(19) United States
(12) Patent Application Publication
(10) Pub. No.: US 2009/0043593 A1
(43) Pub. Date: Feb. 12, 2009

(54) Event Prediction

(75) Inventors: Ralf Herbrich, Cambridge (GB); Thore Graepel, Cambridge (GB); Onno Zoeter, Cambridge (GB); Joaquin Quinonero Candela, Cambridge (GB); Phillip Trelford, Cambridge (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/835,985

(22) Filed: Aug. 8, 2007

(51) Int. Cl. G06F 17/18; G06Q 99/00

(52) U.S. Cl. 705/1

(57) ABSTRACT

There are many situations in which it is desired to predict outcomes of events. In an example, an event prediction system is described which receives variables for a proposed event. The system accesses learnt statistics describing belief about weights associated with the variables and uses the weights to determine probability information that the proposed event will have a specified outcome. The process involves combining the accessed statistics and mapping them into a number representing the probability. In another example, a machine learning process using assumed density filtering is used to learn the statistics from data about observed events. The event prediction system may be used as part of any suitable type of system such as an internet advertising system, an email filtering system, or a fraud detection system.

### BACKGROUND

There are many situations in which it is desired to predict outcomes of events and in many cases it is required to make these predictions in real time and where huge amounts (such as terabytes) of information about past events are available to assist with the prediction.

For example, in the field of fraud detection it is often required to process large amounts of data about credit card transaction behavior and to use that information to make predictions as to whether ongoing or recent transactions are likely to be fraudulent. Other examples include email filtering where it is required to predict whether an email is likely to be spam or not on the basis of past examples of emails being labeled implicitly or explicitly as spam. This type of prediction is also required in the field of internet advertising where advertisers may often be billed an amount depending on a bid made by that advertiser for an advertisement and whether that advertisement, when displayed, is selected by one or more end users (by clicking on a link for example). Thus, internet advertisement channel providers typically need to predict so called “click-through rates”, or the probability that a proposed advertisement will be clicked on by one or more end users.

Previously it has been difficult to make such predictions of event outcomes with acceptable levels of accuracy and to do so in real time, for example, before a credit card transaction is complete, before delivery of an email, or before presentation of a proposed internet advertisement. This is especially difficult where there are large amounts of data about past events to be processed.

It is noted that the invention described herein is not intended to be limited to implementations that solve any or all of the above mentioned disadvantages.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There are many situations in which it is desired to predict outcomes of events. In an example, an event prediction system is described which receives variables for a proposed event. The system accesses learnt statistics describing beliefs about weights associated with the variables and uses the weights to determine probability information that the proposed event will have a specified outcome. The process involves combining the accessed statistics and mapping them into a number representing the probability of the proposed event having a specified outcome by using a link function. In an example, a machine learning process using assumed density filtering is used to learn the statistics from data about observed events. In an example, the event prediction system is used as part of an internet advertising system to predict whether a proposed advertisement will be clicked or not. In another example, the event prediction system is used as part of an email filtering system and in another example it is used as part of a system for detecting fraudulent credit card transactions.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an event prediction system;

FIG. 2 is a schematic diagram of an internet advertising system;

FIG. 3 is a schematic diagram of an email filtering system;

FIG. 4 is a schematic diagram of a credit card fraud detection system;

FIG. 5 is a block diagram of an example method of training an event prediction system;

FIG. 6 is a block diagram of an example method of making a prediction for a proposed event;

FIG. 7 is a block diagram of an example method of billing an internet advertiser;

FIG. 8 is a block diagram of an example method of email filtering;

FIG. 9 is a block diagram of an example method of credit card fraud detection;

FIG. 10 is a block diagram of an example of part of a method of training an event prediction system;

FIG. 11 illustrates an exemplary computing-based device in which embodiments of an event prediction system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an internet advertising system, an email filtering system, or a credit card transaction fraud detection system, the system described is provided as an example and not a limitation. As those skilled in the art will appreciate, the present examples are suitable for application in a variety of different types of systems which require event prediction. A non-exhaustive list of examples is: credit scoring system, search engine, binary classification system and information filtering system.

The term “indicator variable” is used herein to refer to a variable which may take only one of two values such as 0 and 1. Each indicator variable is associated with a feature which describes or is associated with an event. In contrast, a “variable” may take any real value. For example, suppose a feature ‘price’ is specified. A variable associated with this feature may take any real value such as a number of cents. An “indicator variable” with this feature may take a value of say 0 or 1, to indicate for a given event, into which of a specified set of price ranges the event falls.

### An Exemplary System

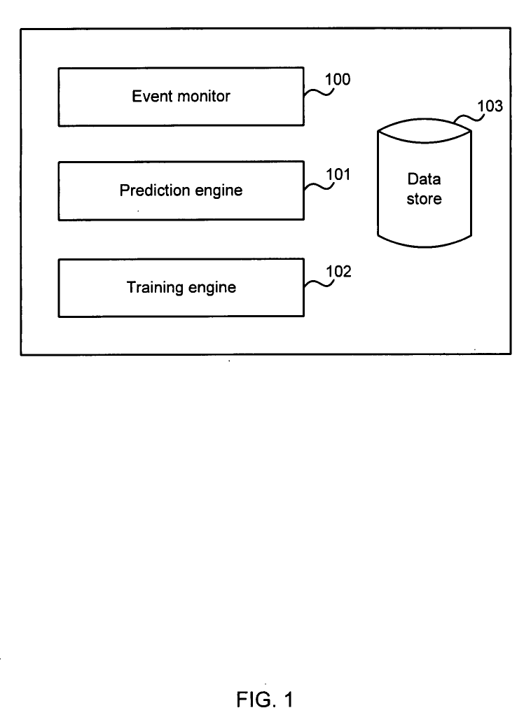

FIG. 1 is a schematic diagram of an event prediction system comprising an event monitor 100 which observes events which occur and their outcomes. The event monitor 100 comprises functionality to access information about the events such as features associated with those events as well as about outcomes of the events. This information may be stored in a data store 103 by the event monitor or other suitable means. A training engine 102 is able to access the historical data about events and event outcomes from the data store 103 and to use this to carry out a training process in order to learn information about weights or other parameters modeling the behavior or process producing the events. The learnt information may be stored in the data store 103. A prediction engine is able to access the learnt information and to use that to predict likelihoods of outcomes for proposed events.

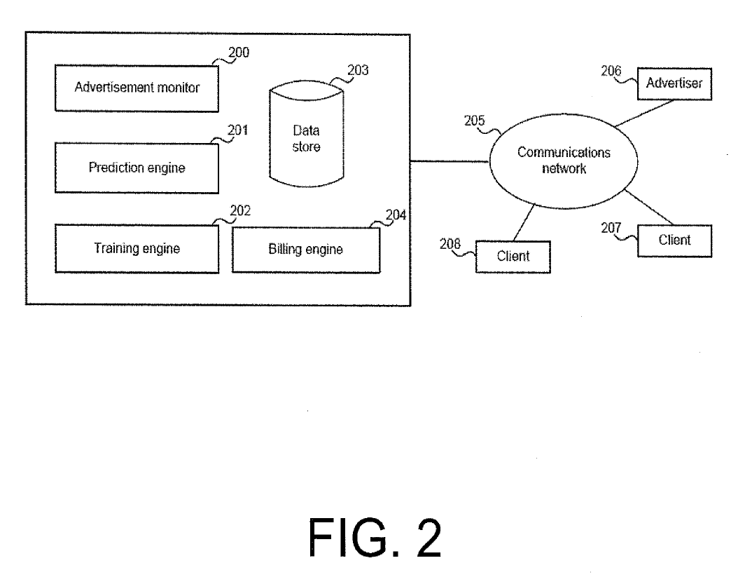

For example, the event prediction system may in some embodiments be an internet advertisement system as illustrated in FIG. 2. Here an advertisement monitor 200 observes advertisements that are displayed as well as whether those advertisements are clicked or not by one or more end users. The advertisement monitor may observe information about the event in which an advertisement is displayed and clicked or not. For example, the advertisement may be presented by a search engine as a result of a search query input by an end user. The monitor may observe features associated with the presentation of the advertisement such as any keywords used in the search query, a time of day of the presentation, information about the advertiser, information about the end user making the search query, or any other information about presentation of the advertisement. The observed information may be stored in a data store 203 and used by a training engine 202 in a similar manner to that described above with reference to FIG. 1. A prediction engine 201 uses the learnt information to predict how likely a proposed advertisement is to be clicked and that prediction information may be used in real time by a billing engine 204 to bill an advertiser 206. One or more such advertisers 206 are in communication with the internet advertisement system via a communications network 205 as are one or more end users or clients 207, 208.

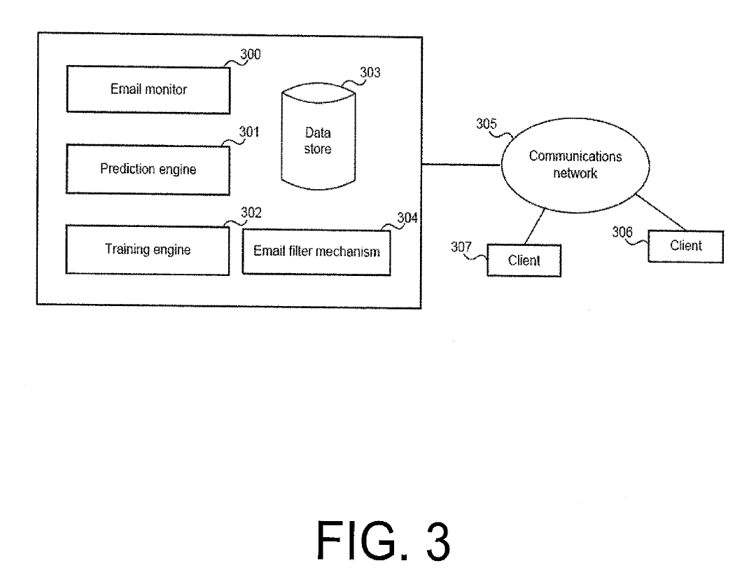

In another example, the event prediction system may be an anti-spam system for email. As illustrated in FIG. 3 an email monitor 300 observes information about or associated with email messages such as information about the sender, words used in the subject line, presence of attachments and other information. The email monitor 300 also observes information about whether those email messages are spam or not. This information may be stored in a data store 303 and used by a training engine 302 in a similar manner as described above with reference to FIG. 1. The results of the training engine may also be stored in the data store 303 and used by a prediction engine 301 to predict whether a given email message is spam or not. The prediction results may be used by an email filter mechanism in real time to block the email, alert users or allow the email as appropriate. The email monitor may receive information about email over a communications network 305 from any suitable source and where clients 306, 307 are observed to send and or receive email.

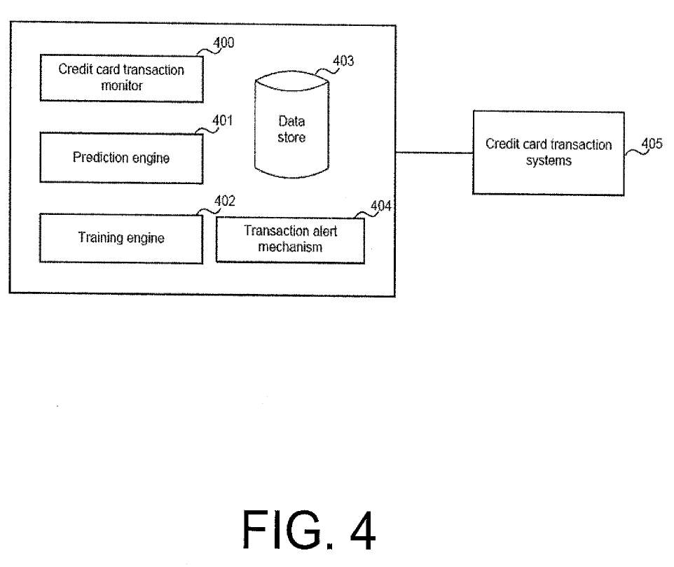

In another example, described with reference to FIG. 4 the prediction system is part of a credit card transaction fraud detection system. Credit card transaction systems 405 provide data to the prediction system so that a credit card transaction monitor 400 is able to observe credit card transactions and to obtain information about those transactions. For example, information about one or more parties to the transaction, information about the time of the transaction, information about the amounts and other information. The information may be stored in a data store 403 together with information about whether the transactions are fraudulent or not. A training engine 402 uses the information in the data store to learn statistics or parameters of a model of credit card transaction behavior in a similar manner as described above with reference to FIG. 1. The results are stored in the data store 403 and used by a prediction engine in real time 401 to predict whether a new credit card transaction is likely to be fraudulent. The prediction results are used by a transaction alert mechanism 404 which may provide output to the credit card transaction systems 405.

### Exemplary Training Method

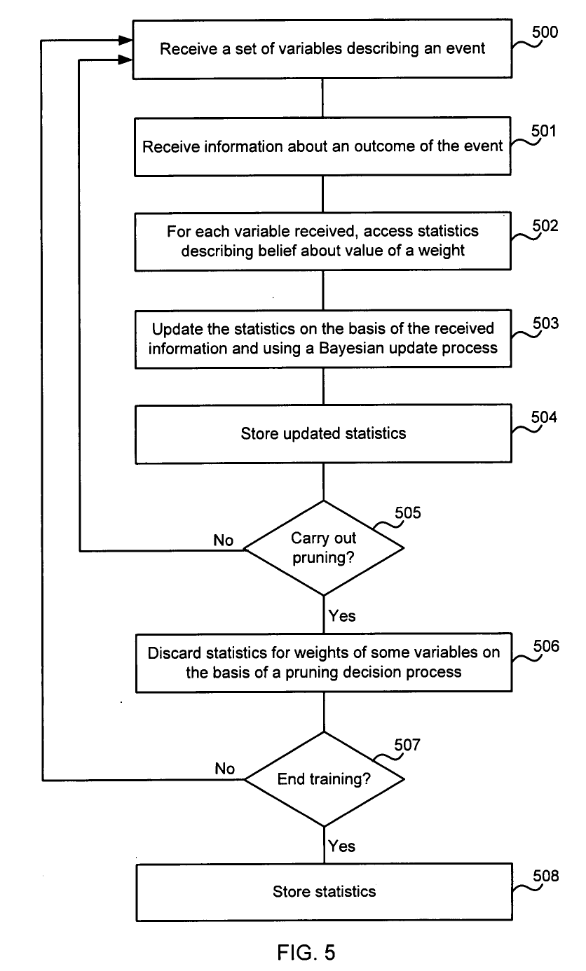

FIG. 5 is a block diagram of an example method of training carried out at a training engine such as any of the training engines of FIGS. 1 to 4.

A set of variables are received describing an event (block 500). For example, these variables are from historical data about past events and their outcomes. The variables received at the training engine may be received from a data store such as any of the data stores of FIGS. 1 to 4. Also received at the training engine is information about an outcome of the event (block 501).

A plurality of features describing or associated with events are pre-specified and for each of these features one or more variables can exist. For example, in the case of internet advertising, an example of a feature may be a time of day of a search query input by a user and resulting in display of an advertisement. Each variable is considered as having an associated weight and information about those weights is learnt during the training process. The weights are used to control how much influence each variable may have on the prediction to be made. Belief about each weight is modeled using any suitable distribution such as a Gaussian distribution and statistics are used to describe those distributions. For example, a mean and a standard deviation are used to describe a Gaussian distribution representing belief about a given weight. However, it is not essential to use a Gaussian distribution; other types of distribution may be used. Also, other statistics may be used instead of or in addition to the mean and standard deviation.

For each variable received for the given event, the training engine accesses statistics describing belief about a weight for the variable (block 502). For example, if the training process has not encountered the particular variables before, the statistics are given default, initial values. Otherwise, the statistics are accessed from the data store.

The statistics are then updated on the basis of the received information and using a Bayesian update process (block 503). An example of a suitable Bayesian update process is described in more detail below. However, it is not essential to use that exact update process, any suitable Bayesian update process may be used.

The updated statistics are stored (block 504) for example in a data store such as any of those of FIGS. 1 to 4. A decision is then made by the training engine as to whether to carry out pruning (block 505). The pruning process involves discarding some of the statistics because it is typically not practical to store all these due to the huge amounts of data involved (for example, terabytes of information). The pruning process may be carried out at specified time intervals, or when memory availability is running low or when any combination of these or other conditions occur. If the decision is made not to carry out pruning, then training continues for another set of variables associated with another observed event. For example, in the field of internet advertising, hundreds of million advertisements may be shown in any 24 hour period.

If the pruning process occurs then statistics are discarded (block 506) for some of the weights on the basis of a pruning decision process which is described in more detail below. If the training process is to end (block 507) the remaining statistics are stored (block 508) otherwise the training process repeats for another set of variables describing another observed event.

The training process may be carried out offline, or during operation of the prediction process to predict event outcomes. A combination of offline training and online training may also be used.

It is also possible for the training process to be carried out using indicator variables as opposed to general variables taking real values. For example, there could be twenty four indicator variables for the time of day feature, one indicator variable for each hour of the day. In this case, only one indicator variable may be “on” for a given event because the event occurs at some point during only one hour of the day. When indicator variables are used, each indicator variable is considered as having an associated weight and information about those weights is learnt during the training process as described above with reference to FIG. 5.

### An Example Prediction Method

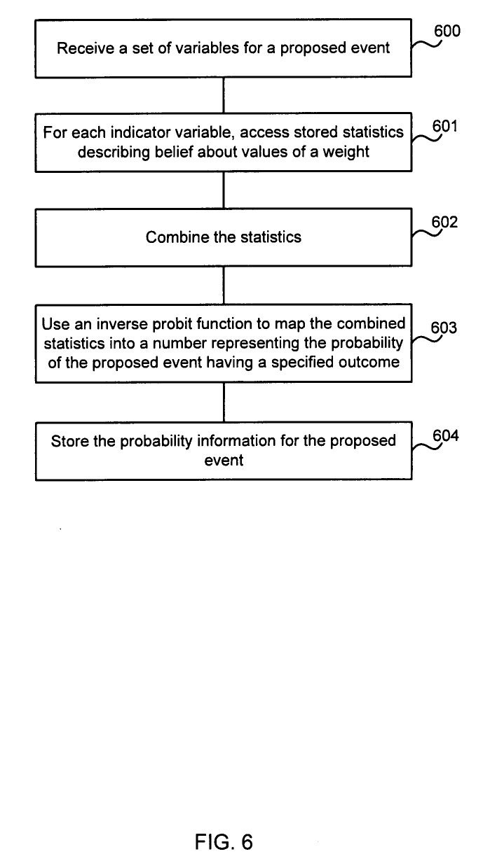

Given a proposed event it is possible to predict an outcome for that event as now described with reference to FIG. 6. The prediction engine receives a set of variables for the proposed event (block 600). The prediction engine accesses, for each variable, stored statistics describing belief about values of a weight (block 601). For example, this information is accessed from a data store such as any of those data stores shown in FIGS. 1 to 4. The stored statistics have been formed during the training process or, if unavailable, are initialized to default values. The statistics of the weights are combined for example and not exclusively in a way that may be consistent with a linear combination of the weights (block 602) and are then mapped to a number representing the probability that the proposed event will have a specified outcome (block 603). The mapping process may comprise using any suitable function. A non-exhaustive list of examples is: inverse probit function, logit function or other link function. An inverse probit function and a logit function are examples of link functions.

The probability information for the proposed event is then stored (block 604). The probability information may then be used in any suitable manner to control a system. The method of FIG. 6 may also be used with indicator variables in place of the general variables taking real values.

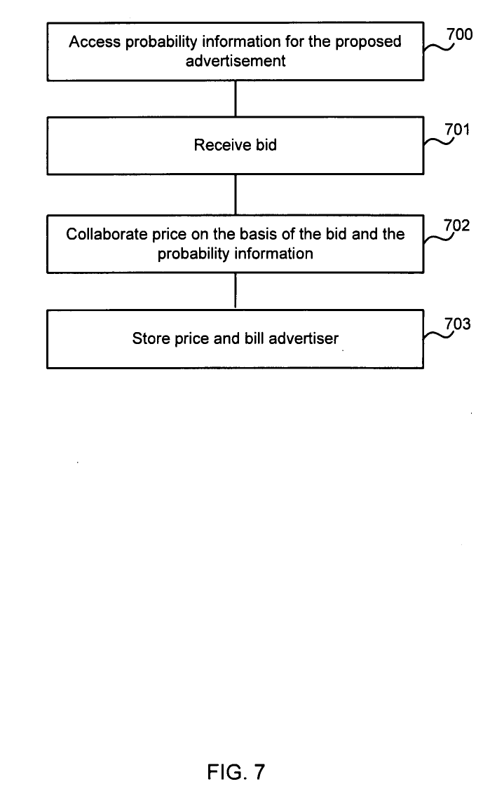

For example, in the case of an internet advertising system, probability information for a proposed advertisement being clicked is accessed (FIG. 7, block 700) a bid is received from an advertiser for the advertisement (block 701) and a price for the advertisement (should it be clicked) is calculated on the basis of the bid and the probability information (block 702) and possibly other information. The price is then stored and the advertiser billed as appropriate (block 703).

In another example, the probability information may relate to an internet advertisement being clicked and that click resulting in a sale or other successful outcome for the advertiser. This is referred to as a successful conversion of the internet advertisement into a sale or other successful outcome for the advertiser. In this case the process of FIG. 7 is similar and the price is calculated on the basis of the bid and the probability of successful conversion.

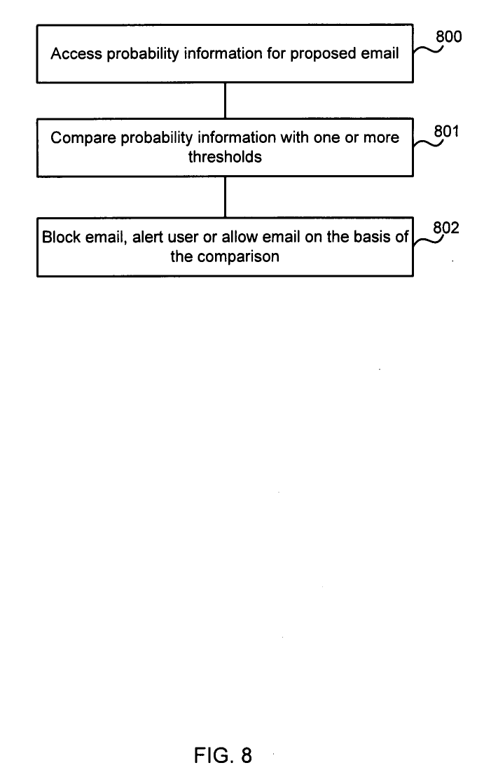

In another example (see FIG. 8) the probability information relates to whether a proposed email is spam or not. The probability information is accessed (block 800) by the anti-spam system and compared with one or more specified thresholds (block 801). The anti-spam system then blocks the email, alerts a user or allows the email on the basis of the comparison (block 802).

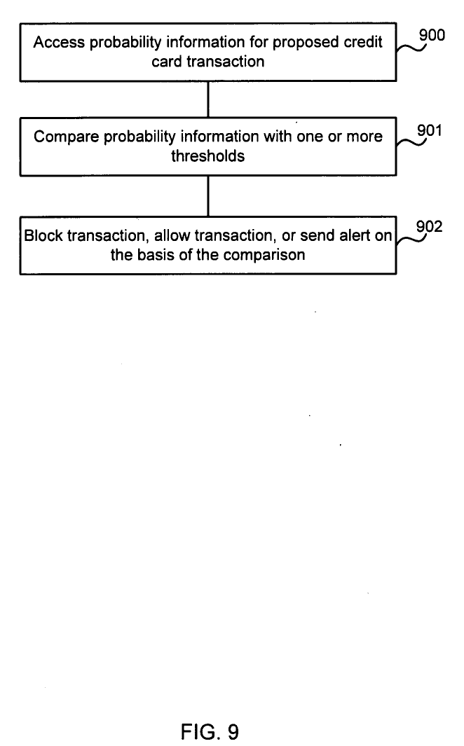

In another example (see FIG. 9) the probability information relates to whether a credit card transaction is fraudulent or not. The probability information is accessed (block 900) and compared with one or more specified thresholds (block 901). The anti-fraud system then blocks the transaction, allows the transaction and/or triggers alerts on the basis of this comparison (block 902).

As mentioned above the methods described herein comprise modeling belief about weights for variables describing factors relating to an event. Any suitable model may be used. For example, a probability distribution is used to model the belief. A bell-curve belief distribution such as a Gaussian distribution may be used, or any other suitable probability distribution. For example, a bimodal or skewed distribution.

Statistics describing the distribution are used in the models as mentioned above. For example, in the case that a Gaussian distribution is used, its mean μ and standard deviation σ may be selected.

In the case that a Gaussian distribution is used, for example, to model belief about a value of a weight, the area under the distribution curve within a certain range corresponds to the belief that the weight value will lie in that range. As the prediction system learns more about a weight the standard deviation of the distribution tends to become smaller, more tightly bracketing the system's belief about the value of that weight.

### Example of Update Mechanism

As mentioned above, the update mechanism may use techniques based on Bayes' law. In the case of an event comprising presentation of an advertisement which is clicked, then an example update rule is as follows:

$${μ}_{i}^{′} ← {μ}_{i} + \frac{{σ}_{i}^{2} {x}_{i}^{2}}{C} \cdot v ( \frac{{\sum }_{i = 1}^{N} {μ}_{i} {x}_{i}}{C} , O ) \\ {σ}_{i}^{{2}^{′}} ← {σ}_{i}^{2} [ 1 - \frac{{σ}_{i}^{2} {x}_{i}^{2}}{{C}^{2}} - w ( \frac{{\sum }_{i = 1}^{N} {μ}_{i} {x}_{i}}{C} , O ) ]$$

In the case of an event comprising presentation of an advertisement which is not clicked, then an example update rule is as follows:

$${μ}_{i}^{′} ← {μ}_{i} - \frac{{σ}_{i}^{2} {x}_{i}^{2}}{C} \cdot v ( \frac{- {\sum }_{i = 1}^{N} {μ}_{i} {x}_{i}}{C} , O ) \\ {σ}_{i}^{{2}^{′}} ← {σ}_{i}^{2} [ 1 - \frac{{σ}_{i}^{2} {x}_{i}^{2}}{{C}^{2}} \cdot w ( \frac{- {\sum }_{i = 1}^{N} {μ}_{i} {x}_{i}}{C} , O ) ]$$

In these equations C is given by:

$$C = {\sum }_{i = 1}^{N} {σ}_{i}^{2} {x}_{i}^{2} + {β}^{2}$$

In some embodiments the value of x in the above update equations is either 0 or 1 depending on whether an indicator variable is “on” or not as mentioned above. That is, in some embodiments, indicator variables are grouped into N groups with one group per feature. For example, an example feature may be the age of an end user (advertisement viewer, email receiver, credit card transaction party etc.). In this case a plurality of indicator variables for the feature may be age ranges, for example, 0 to 9, 10 to 19, 20 to 29, 30 to 39 etc. However, for a given event only one of the age ranges may be on. That is, an end user's age is only present in one of the bins. In this case 0 and 1 may be used to represent whether an indicator variable is on or not. By using groups of indicator variables in this way it is possible to reduce processing and memory requirements, which is especially important in many applications where the quantities of data to be analyzed are huge. However, it is not essential to use groups of indicator variables where only one indicator variable may be on in any one group. In this case x in the above equations may have values other than 0 or 1.

In these equations, the only unknown is β² which is the variance of the feedback around the weight of each variable. β² is thus a configurable parameter and for example is set to 1. The functions v and w are given by:

v(t)=N(t)/F(t)

w(t)=v(t)*(v(t)−t)

Where the symbols N and F represent the density of the Gaussian distribution function and the cumulative distribution function of the Gaussian, respectively. The symbol t is simply an argument to the functions. Any suitable numerical or analytic methods can be used to evaluate these functions such as those described in Press et al., Numerical Recipes in C: the Art of Scientific Computing (2^{nd}. Ed.), Cambridge, Cambridge University Press, ISBN-00521-43108-5.

These update equations can be thought of as Bayesian update equations. They receive a set of variables (which may be either indicator variables or general variables taking real values) describing an observed event together with event outcome information. The equations update the values of the mean and standard deviation for each weight in light of the data, assuming that the posterior distribution over the weights is again Gaussian. With a single pass over the training data this procedure is referred to as Gaussian density filtering and more generally as assumed density filtering (ADF). It is also possible to use expectation propagation (EP) whereby ADF is iterated to convergence. Use of Expectation Propagation is described in detail in “A family of algorithms for approximate Bayesian inference” 2001, Thomas Minka, MIT PhD thesis. This may give a more exact solution but requires more computational resources.

The statistics (mean and standard deviation) may be stored in any suitable manner. For example, using vectors. Learning the distribution for observed data over such a vector of statistics for the weights is a computationally difficult task and the assumed density filtering technique enables a solution to be obtained.

Given a value of the mean and standard deviation for each weight, the predicted probability of outcome A for a given event is given by:

$$p ( A \vert event ) = Φ ( \frac{{\sum }_{i} {x}_{i} {μ}_{i}}{\sqrt{{β}^{2} + {\sum }_{j} {x}_{j}^{2} {σ}_{j}^{2}}} ) .$$

The sums are over all the features weighted by feature values for the given event. The function Φ(x) is the cumulative normal distribution function which is also known as the inverse probit function. However, it is also possible to use other mapping functions Φ(x) here such as a logit function or other link function.

For example, given a known set of weights a prediction for a particular proposed event may be made by adding the weights of all the variables for the event. The resulting sum is a real number. An inverse probit function may be used to map this number to a probability between 0.0 and 1.0.

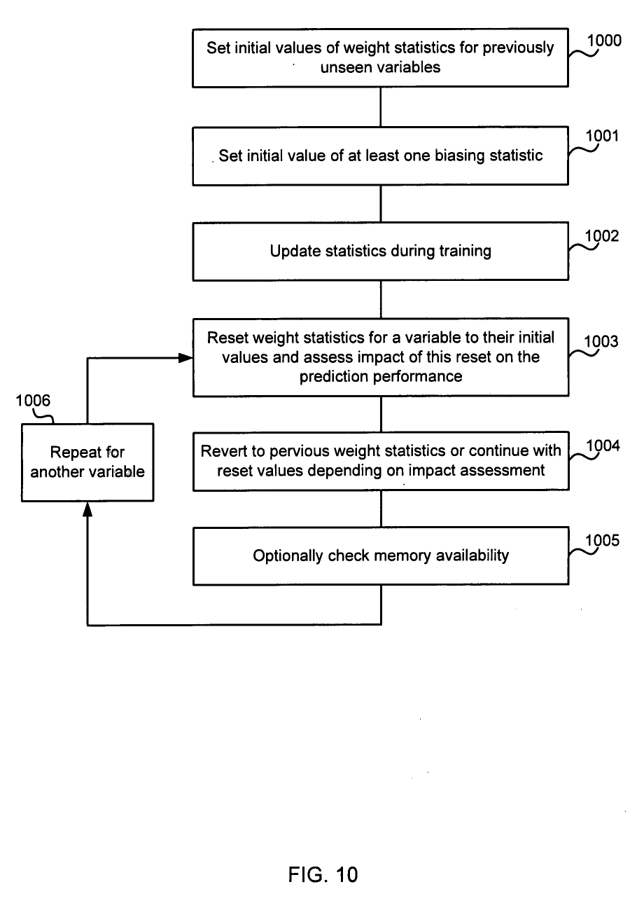

Since many of the features used in the prediction process may take very many values (variables) the methods described herein are arranged to keep track of only those weights which actually affect the prediction. As mentioned above, weights are initialized to a common prior and pruning is carried out at intervals to eliminate those weight parameters that have remained close to the prior. This is now described in more detail with reference to FIG. 10.

FIG. 10 is a block diagram of an example method of setting initial values for weight statistics and also of pruning. This method may be carried out as part of the training process of FIG. 5 for example.

During the training process, if the training engine is presented with variables for an event where it has not previously seen those variables, it sets initial values of weight statistics for those unseen variables (block 1000). These initial values may be referred to as the prior. In some examples, the means are all initialized to 0.0 except for a “dummy” mean μ₀ which is set to a specified value in order to provide a bias (block 1001). For example, this dummy or biasing mean is set such that the a-priori prediction probability is a specified value such as 0.02=2% or any other suitable value. In the case of internet “paid search” advertising, where one might assume that around 2% of all displayed adverts are clicked, the a-priori prediction probability is appropriately 2%. However, this biasing mean and an associated biasing variance may be set at other values depending on the particular application, and can be learnt from a separate set of training data. When a previously unseen variable is introduced, this may inappropriately influence the prediction results. The biasing mean may be used to prevent or reduce the effects of this. The following equation may be used to determine an appropriate initial value for the biasing mean.

$${Φ}^{- 1} ( p ( A \vert event ) ) - \sqrt{{\sum }_{i = 1}^{N} {x}_{i}^{2} {σ}_{i}^{2} + {β}^{2}} = {μ}_{bias}$$

In some examples, where indicator variables are used, the biasing mean and variance may be associated with an indicator variable which is always on and which may be referred to as a bias indicator variable. As mentioned above, the biasing mean and variance may be learnt. Since all observations help in this learning process it is relatively fast.

The standard deviation values for previously unseen variables are distributed equally so that for example Σᵢσᵢ²=1.0. Other values for the sum of the variances can be chosen by appropriately tuning on a separate set of data during training time. For example, different values of σᵢ² may lead to a slightly different learning behavior. Larger variances tend to result in faster adaptation and smaller variances in more conservative updates. The variances may be chosen differently for different variables.

The training engine proceeds to update the statistics during the training process (block 1002) as described above. If the pruning process is entered, then, for a given variable, the weight statistics are reset to their initial values (re-initialized) and an assessment is made about the impact of this reset on the prediction performance (block 1003). For example, in some embodiments this is achieved by computing a difference Δᵢ as follows:

$${Δ}_{i} = \vert Φ ( \frac{{μ}_{bias} + {μ}_{i}}{\sqrt{{σ}_{bias}^{2} + {σ}_{i}^{2} + {β}^{2}}} ) - Φ ( \frac{{μ}_{bias} + O}{\sqrt{{σ}_{bias}^{2} + {σ}_{o}^{2} + {β}^{2}}} ) \vert$$

If this difference is less than a specified value such as 0.01% then the weight statistics for this variable are discarded (re-initialized).

In another embodiment a Kullback-Leibler divergence may be used to make this assessment. In this case the following equation is used where p is the first term in the difference calculation above and q is the second term in the difference calculation above.

$$KL ( p , q ) = p log ( \frac{q}{p} ) + ( 1 - p ) log ( \frac{1 - q}{1 - p} )$$

The pruning process then reverts to the previous weight statistics or continues with the reset values depending on the impact assessment (block 1004). An optional check for memory availability is made (1005) for example, if the pruning process is carried out only until memory availability is sufficient to continue the training process. The pruning process then repeats for another variable (block 1006).

The methods described above with reference to FIG. 10 may also be used with indicator variables in place of the general variables taking real values.

As mentioned above, a plurality of specified features are used during the training and prediction process. The particular features chosen depend on the particular application concerned whether it be internet advertising, credit card fraud detection or other applications. In addition, the features may be selected by making offline analysis of the training data in order to select those features which are most effective for use in the prediction process.

In some embodiments the event prediction system is used in the field of internet advertising. For example, it may be used to predict not only whether a displayed advertisement will be clicked or not, but also whether any click is likely to result in a successful conversion for the advertiser. In this case the probability that a conversion will occur given a proposed event X may be given as follows:

$$\begin{matrix}P ( conversion = True \vert X ) = P ( conversion = True \vert click = True , X ) P ( click = True \vert X ) + \\ P ( conversion = True \vert click = False , X ) P ( click = False \vert X ) \\ = P ( conversion = True \vert click = True , X ) P ( click = True \vert X )\end{matrix}$$

In the above, line 2 follows from line 1 since
P(conversion=True|click=False,X)=0, i.e., there can only be a conversion if there was a click.

In this case the methods described herein may be used to predict the probability that a click will occur P(click=T|X) for a proposed advertisement. The methods described herein may also be used to predict the probability that a conversion will occur given a click. In this case training data comprising information about clicks that have resulted in successful conversions is required. In this way the probability of a successful conversion may be predicted.

### Exemplary Computing-Based Device

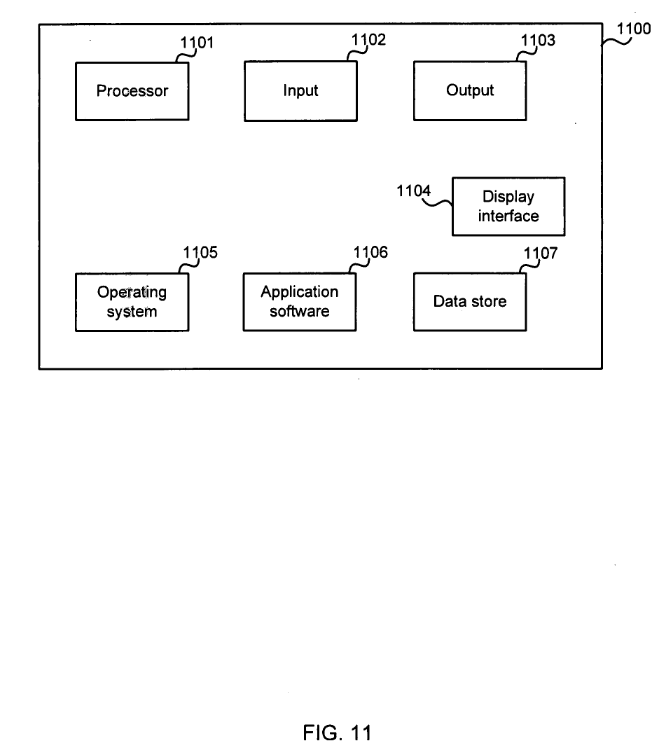

FIG. 11 illustrates various components of an exemplary computing-based device 1100 which may be implemented as any form of a computing and/or electronic device, and in which embodiments of an event prediction system may be implemented.

The computing-based device 1100 comprises one or more inputs 1102 which are of any suitable type for receiving media content, Internet Protocol (IP) input, information about email, information about internet advertisements, information about credit card transactions, information about events whose outcomes are to be predicted etc. Also provided is an output 1103 for providing output comprising at least prediction results to another system for controlling that system.

Computing-based device 1100 also comprises one or more processors 1101 which may be microprocessors, controllers or any other suitable type of processors for processing computing executable instructions to control the operation of the device in order to predict outcomes of events. Platform software comprising an operating system 1105 or any other suitable platform software may be provided at the computing-based device to enable application software 1106 to be executed on the device.

The computer executable instructions may be provided using any computer-readable media, such as memory 1107. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

A display interface 1104 may be provided such as an audio and/or video output to a display system integral with or in communication with the computing-based device. The display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of predicting the outcome of a proposed event comprising:
receiving a plurality of variables describing the proposed event;
for each variable, accessing stored statistics describing belief about values of a weight, the stored statistics having been learnt using a machine learning process comprising assumed density filtering;
combining the statistics;
mapping the combined statistics into a number representing the probability of the proposed event having a specified outcome by using a link function; and
storing the probability information for the proposed event.

2. A method as claimed in claim 1 which further comprises using the probability information to control a system selected from any of: an internet advertising system, a credit card fraud detection system, an email filtering system, a credit scoring system, a search engine, a binary classification system and an information filtering system.

3. A method as claimed in claim 1 wherein the step of receiving variables comprises receiving indicator variables where each indicator variable may take only one of two possible values to indicate whether it is on.

4. A method as claimed in claim 3 wherein the step of receiving the indicator variables comprises receiving indicator variables, each indicator variable being a member of a group and each group being associated with a specified feature from a plurality of specified features describing events of which the proposed event is an instance.

5. A method as claimed in claim 4 wherein the step of receiving the proposed indicator variables comprises receiving information about indicator variables that are on and where only one indicator variable may be on per group.

6. A method as claimed in claim 1 which further comprises learning the stored statistics using a machine learning process.

7. A method as claimed in claim 6 which further comprises updating the statistics in the light of observed data and using a Gaussian density filtering process.

8. A method as claimed in claim 6 which further comprises carrying out a pruning process in order to discard at least some of the stored statistics.

9. A method as claimed in claim 8 wherein the pruning process comprises assessing, for a particular variable, how much influence those stored statistics have on accuracy of the probability information.

10. A method as claimed in claim 6 which further comprises, for previously unseen variables, initializing statistics to default values.

11. A method of predicting the outcome of a proposed event comprising:
carrying out a training process using assumed density filtering in order to learn statistics describing belief about values of weights;
receiving a plurality of variables describing the proposed event;
for each variable, accessing statistics from the training process describing belief about values of a weight;
combining the statistics;
mapping the combined statistics into a number representing the probability of the proposed event having a specified outcome by using a link function; and storing the probability information for the proposed event.

12. A method as claimed in claim 11 which further comprises using the probability information to control a system selected from any of: an internet advertising system, a credit card fraud detection system, an email filtering system, a credit scoring system, a search engine, a binary classification system and an information filtering system.

13. A method as claimed in claim 11 wherein the step of receiving the variables comprises receiving indicator variables where each indicator variable may take only one of two possible values to indicate whether it is on.

14. A method as claimed in claim 13 wherein the step of receiving the indicator variables comprises receiving indicator variables, each indicator variable being a member of a group and each group being associated with a specified feature from a plurality of specified features describing events of which the proposed event is an instance.

15. A method as claimed in claim 11 wherein the training process comprises a pruning process whereby at least some of the learnt statistics are discarded on the basis of an assessment of the impact of discarding those statistics on accuracy of the probability information.

16. A method as claimed in claim 11 wherein the training process comprises using Gaussian density filtering.

17. A method as claimed in claim 11 wherein the training process comprises using expectation propagation.

18. A method as claimed in claim 11 wherein the proposed event is display of an internet advertisement and wherein the probability information is related to the probability that if a proposed internet advertisement is clicked, that a conversion will result for an associated advertiser.

19. A method as claimed in claim 11 wherein the proposed event is display of an internet advertisement and wherein the probability information is related to the probability that a proposed internet advertisement will be clicked.

20. One or more device-readable media with device-executable instructions for performing steps comprising:
receiving a plurality of variables describing a proposed event;
for each variable, accessing stored statistics describing belief about values of a weight, the stored statistics having been learnt using a machine learning process comprising assumed density filtering;
combining the statistics;
mapping the combined statistics into a number representing the probability of the proposed event having a specified outcome by using a link function; and
storing the probability information for the proposed event.
